(19) United States
(12) Patent Application Publication
(10) Pub. No.: US 2020/0043103 A1
(43) Pub. Date: Feb. 6, 2020

(54) PROACTIVE OFFERS

(71) Applicant: Experian Information Solutions, Inc., Costa Mesa, CA (US)

(72) Inventor: Bogdan Sheptunov, St. Charles, IL (US)

(73) Assignee: Experian Information Solutions, Inc., Costa Mesa, CA (US)

(21) Appl. No.: 14/022,508

(22) Filed: Sep. 10, 2013

Related U.S. Application Data
(60) Provisional application No. 61/699,980, filed on Sep. 12, 2012.

(51) Int. Cl. G06Q 50/00; G06Q 30/02

(52) U.S. Cl. CPC G06Q 50/01; G06Q 30/0269

(57) ABSTRACT

Methods and systems are disclosed that determine proactive offers to send to individuals of interest. The proactive offers may be determined based on a scanning of user comments on social networks, a determination of identities associated with the users, a determination of individuals related to the identities and a level of interest associated with the related individuals.

### CROSS-REFERENCE TO RELATED APPLICATIONS

This application claims the benefit under 35 U.S.C. § 119 of U.S. provisional application No. 61/699,980, filed Sep. 12, 2012, which is incorporated by reference herein in its entirety.

### BACKGROUND

Social network media is becoming increasingly popular as a source of information for business decisions.

### SUMMARY

An entity may wish to proactively contact current or potential customers with various marketing products or services, or customer service actions based on a value associated with the respective customers. In order to determine which product, service or action to offer the respective customer, social networks can be scanned to determine comments made by users of the social networks. The comments may then be analyzed to determine the identity of the users associated with the comments made, and to also determine individuals related to the users making the comments (or individuals within the so-called sphere of influence of those users). The individuals determined to be related to the users making the comments may then be categorized into various levels of value to the entity. Then, depending on the various levels of value to the entity, the appropriate product, service or action is offered to the individual.

### BRIEF DESCRIPTION OF THE DRAWINGS

FIG. 1 is a block diagram showing an embodiment in a proactive offer system in communication with a network and various systems are also in communication with the network.

FIG. 2 is a flowchart illustrating an embodiment of a method for determining an action to perform based on an identified value of a customer or potential customer.

FIG. 3 is a diagram illustrating sample data and rules that may be used by various modules of an embodiment of the proactive offer system.

FIG. 4 is a table listing some variables and associated actions that may be used by an embodiment of the proactive offer system.

FIG. 5 is a block diagram illustrating sample data that may be communicated between various modules of an embodiment of the proactive offer system.

### DETAILED DESCRIPTION

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

### Example System Implementation

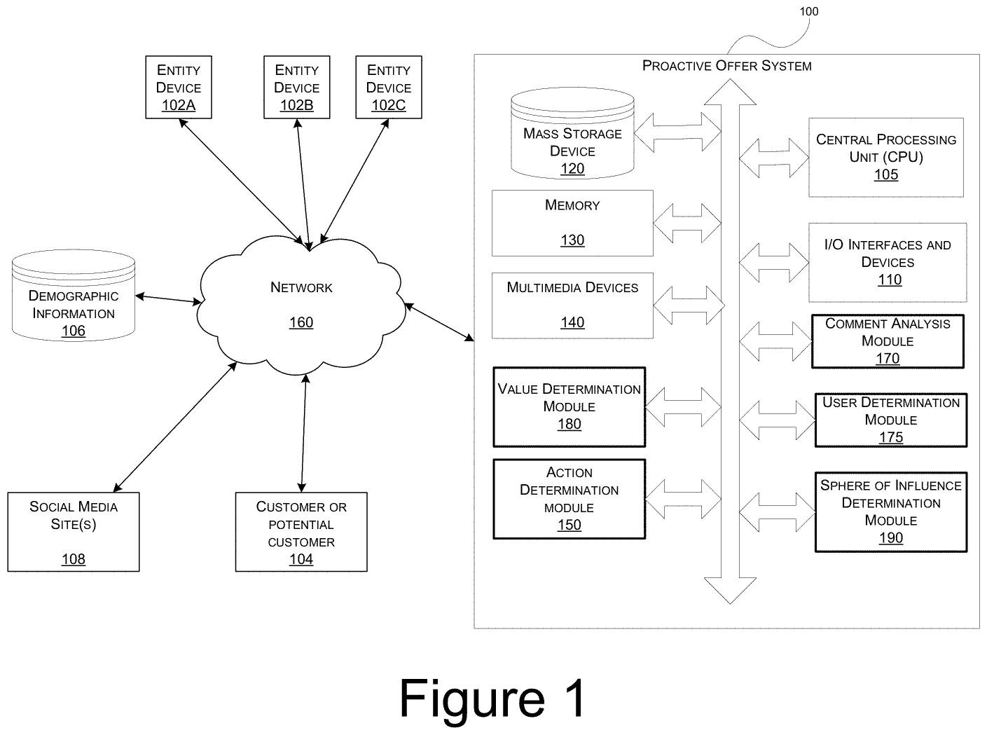

FIG. 1 is a block diagram showing an embodiment of a proactive offer system 100 (or simply “computing system 100”) in communication with a network 160 and various systems are also in communication with the network 160.

In the embodiment of FIG. 1, the proactive offer system 100 receives requests from various entity devices 102 (including, collectively or individually, entity device 102A, 102B, and/or 102B) for information that is useful in providing incentives, offers, and/or other information to current and/or prospective customers of the entities. For example, a first entity operating entity device 102A may request information from the proactive offer system 100 that is useful in identifying existing customers to provide special incentives to. Similarly, the second entity operating entity device 102B may request that the proactive offer system 100 not only identifies prospective customers, but also contacts prospective customers of the second entity based on rules defined by the second entity. In other embodiments, the requesting entities may interact with the offer system 100 in various ways and may receive various data from the offer system 100 and/or instruct the offer system to perform actions (e.g., marketing actions) on behalf of the requesting entity.

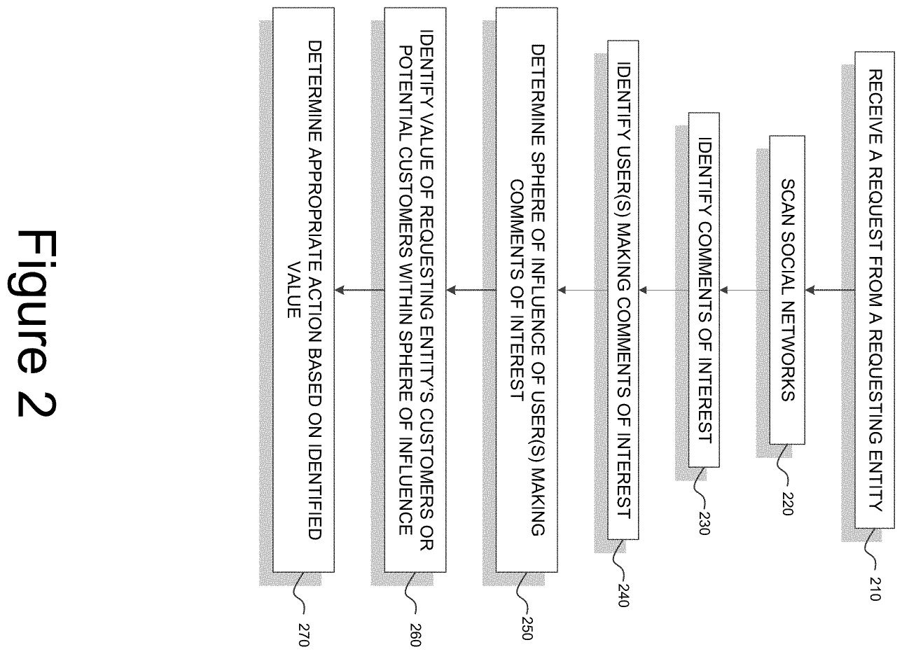

In response to a request from a requesting entity, the computing system 100 may receive information from various data sources regarding consumers, such as from various social network or media sites. The acquired information may be processed, such as by the modules of the proactive offer system 100, in order to identify content (e.g., text posts, microblogs, online comments, photos, etc.) posted by consumers that may be of interest to the requesting entity. For example, a social networking comment regarding a brand of a particular requesting entity may be interesting to the requesting entity in order to identify potential positive and/or negative effects of the comment on current and/or prospective customers of the entity that may view the social networking comment. The operation of the computing system 100 in identifying content of interest to a requesting entity and performing the desired action in response to processing the content (e.g., as defined by entity-specific rules) is discussed in further detail with reference to FIGS. 2-5.

Once comments of interest have been identified, the proactive offer system 100 may determine the real-life identities of respective commenters (e.g., the individuals associated with respective online identities). Then, using the real-life identities, the proactive offer system may use information, such as for example demographic information 106, to determine the sphere of influence of such individuals. For example, the demographic information 106 may be used to determine individuals related to the commenting individual. In some embodiments, the demographic information 106 may be gathered from a variety of different, trusted sources. The demographic information may include consumer information, such as for example identity information, and other demographic related information including credit information of consumers, creditworthiness of consumers, and the like.

In some embodiments, the relationship may be determined based on information regarding the individuals' current or past residence address. In some embodiments, the relationship may be determined based on the individuals' current or past employment information. In some embodiments, the relationship may be based on public record information such as marriage records, and the like. Once a commenting individual's sphere of influence is determined, the individuals identified within the commenter's sphere of influence may be identified as being current customers of the requesting entity, or, alternatively, as potential future customers. Based on this determination, a proactive offer to present to a current or potential customer of an entity may be formulated. After a proactive offer has been formulated, the offer may be provided to the requesting entity. The requesting entity may then decide to contact the customer or potential customer 104 with the recommended offer. In some embodiments, instead of providing the recommended offer to the requesting entity, the proactive offer system 100 may contact the customer or potential customer 104 directly, on behalf of the requesting entity, with the recommended proactive offer.

The computing system 100 includes, for example, a personal computer that is IBM, Macintosh, or Linux/Unix compatible or a server or workstation. In one embodiment, the computing system 100 comprises a server, a laptop computer, a cell phone, a personal digital assistant, a kiosk, or an audio player, for example. In one embodiment, the exemplary computing system 100 includes one or more central processing unit (“CPU”) 105, which may each include a conventional or proprietary microprocessor. The computing system 100 further includes one or more memory 130, such as random access memory (“RAM”) for temporary storage of information, one or more read only memory (“ROM”) for permanent storage of information, and one or more mass storage device 120, such as a hard drive, diskette, solid state drive, or optical media storage device. Typically, the modules of the computing system 100 are connected to the computer using a standard based bus system. In different embodiments, the standard based bus system could be implemented in Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing system 100 may be combined into fewer components and modules or further separated into additional components and modules.

The computing system 100 is generally controlled and coordinated by operating system software, such as Windows XP, Windows Vista, Windows 7, Windows 8, Windows Server, Unix, Linux, SunOS, Solaris, or other compatible operating systems. In Macintosh systems, the operating system may be any available operating system, such as MAC OS X. In other embodiments, the computing system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 100 may include one or more commonly available input/output (I/O) devices and interfaces 110, such as a keyboard, mouse, touchpad, and printer. In one embodiment, the I/O devices and interfaces 110 include one or more display devices, such as a monitor, that allows the visual presentation of data to a user. More particularly, a display device provides for the presentation of GUIs, application software data, and multimedia presentations, for example. The computing system 100 may also include one or more multimedia devices 140, such as speakers, video cards, graphics accelerators, and microphones, for example.

In the embodiment of FIG. 1, the I/O devices and interfaces 110 provide a communication interface to various external devices. In the embodiment of FIG. 1, the computing system 100 is electronically coupled to a network 160, which comprises one or more of a LAN, WAN, and/or the Internet, for example, via a wired, wireless, or combination of wired and wireless, communication link. The network 160 communicates with various computing devices and/or other electronic devices via wired or wireless communication links. The computing system 100 may also communicate with various social media sites 108 via the network 160. The computing system 100 may also be in communication with various user devices 102A, 102B, 102C. In some embodiments, the user devices 102 may be associated with a requesting entity wishing to formulate proactive offers for customers or potential customers.

According to FIG. 1, information is provided to the computing system 100 over the network 160 from one or more data sources. The data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 1, the computing system 100 also includes a comment analysis module 170, a user determination module 175, a sphere of influence determination module 190, a value determination module 180 and an action determination module 150. These various modules may be stored in the mass storage device 120 as executable software codes that are executed by the CPU 105. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 1, the computing system 100 is configured to execute the comment analysis module 170, user determination module 175, sphere of influence determination module 190, value determination module 180 and action determination module 150 in order to receive a request from an entity, receive demographic information as well as information from social media sites and, based on an analysis and processing of the received information, help formulate proactive offers for the requesting entity, as well as any other functionality described elsewhere in this specification. These modules are further to discussed below with reference to FIGS. 2-5. Depending on the embodiment, the offer system 100 may include fewer or additional modules and the modules may be combined in various manners. For example, in one embodiment the user determination module 175 and the comment analysis module 170 may be included in a single module.

FIG. 2 is a flowchart illustrating an embodiment of a method for determining an action to perform based on an identified value of a customer or potential customer. Embodiments of the method illustrated in FIG. 2 may be performed by the various modules of the computing system 100 or any other suitable computing device. Depending on the embodiment, the method of FIG. 2 may include additional or fewer blocks and/or the blocks may be performed in an order that is different than illustrated.

The method starts at block 210, wherein a request is received from a requesting entity. In some embodiments, the request may be provided by the requesting entity using an entity device 102. The request from the requesting entity may include a request for the proactive offer system 100 to determine the appropriate action for the requesting entity to perform with respect to determined individuals. In such embodiments, all of the blocks in FIG. 2 following block 210 may be performed by the proactive offer system. Alternatively, the request may include a request to only determine the sphere of influence of users making comments on social networks that are of interest to the requesting entity. In such embodiments, some of the blocks in FIG. 2 following block 210 may be performed by the requesting entity. In some embodiments, the requesting entity may also include a list of its current and/or prospective customers with the request. The list of current customers may also include an indication of the value associated with the customers, based on the entity's business rules.

Once a request is received, the method moves to block 220, where social networks are scanned. In some embodiments, other data sources and/or sites may also be scanned, such as any data source that may include consumer content. In some embodiments, the requesting entity may have already scanned the social networks, and may include certain comments of interest to it along with the request at block 210. In such embodiments, the proactive offer system 100 may move straight from block 210 to block 240. Otherwise, the method moves to block 230, where, following the scan of the networks, comments of interest to the requesting entity are identified.

In block 230, comments of interest to the requesting entity are identified, such as based on various criteria established by the requesting entity and/or the proactive offer system 100. For example, comments related to a particular product or service offered by the requesting entity, or comments related to particular employees or business locations of the entity, or comments containing various sentiments may be identified as being of interest to the requesting entity.

After comments of interest are identified, the method moves to block 240, where a user making a given comment is identified. Generally, user identities on social networks may or may not be indicative of the users' true identities. Therefore, at block 240, the proactive offer system 100 may use various information, including for example demographic information 106, to determine the identity associated with the social network user. In some embodiments, this determination may be performed by using information from a customer relationship management (CRM) repository associated with the respective social networks, for example. In other embodiments, the identity of a user posting, (or other content) may be identified in any other manner. In some embodiments, the actual identity of the user may not be determined but the method may continue using an online identity of the user. In this embodiment, the sphere of influence of the user may be determine based on relationships with that online identity on one or more social networks, and communications to individuals within the user's sphere of influence may be provided via communication functionality built into those one or more social networks.

In another embodiment, comments of only the requesting entity's customers and/or individuals within the respective spheres of influence of those customers are analyzed to determine whether or not any of the content is of interest to the requesting entity, rather than processing content from all posters on the scanned social networks. For example, the proactive offer system 100 may determine online identities of customers of a requesting entity and then scan the social networks for comments provided by those online identities. The identified comments may then be analyzed to determine if any of the comments match rules for identifying comments of interest to the requesting entity.

Once the identity of a user making a comment is determined, the identity may be compared to the list of customers received from the requesting entity at block 210 to determine if the user making the comment on the social network is a current customer of the requesting entity.

Then, at block 250, the proactive offer system 100 determines the sphere of influence of each user having been identified as making comments of interest and/or identified as being a current or potential customer of the requesting entity. The sphere of influence of a user may include individuals deemed to be related to the user in one capacity. Some examples of relationships may be: household relationship (e.g. residing at the same postal address), employment relationship (e.g. working for the same employer), familial relationship, and the like. The sphere of influence of a user may be determined using information such as demographic information 106. Individuals in a particular user's sphere of influence may not be limited to those within the user's social networks. For example, a user's sphere of influence may include individuals who are not present on said social networks. The determination of the sphere of influence may include reconciliation of information from multiple channels.

Once a user's sphere of influence has been determined, then the method moves to block 260, where the individuals found to be within a user's sphere of influence are compared to the requesting entity's list of customers or potential customers (e.g., criteria for potential customers). For individuals found to be on the requesting entity's list, a value associated with each individual may be accessed or determined. In some embodiments, as mentioned above, the value associated with customers (or potential customers) may be provided by the requesting entity in conjunction with the request at block 210. In other embodiments, the proactive offer system 100 may determine the value associated with the customers (or potential customers). For example, the value may be determined based on the analysis of the comments made by the user at block 230. For example, if the user comments reference a related individual's reaction to a given product, the information may be used to ascertain the value of the related individual to the requesting entity. In yet other embodiments, the value associated with various individuals may be provided to the proactive offer system 100 and/or to the requesting entity by a third party, such as, for example, marketing agency.

Then, at block 270, depending on the value identified for the various individuals (e.g., customers and/or prospective customers) within a user's sphere of influence, the appropriate action to perform is determined. In some embodiments, the proactive offer system 100 may help the requesting entity identify the appropriate action based on rules defined by the requesting entity and/or the proactive offer system. In some embodiments, the appropriate action may be based on information gathered from comments from other users on the social networks. For example, if the comments from the users indicate that a related individual is really interested in a product of the requesting entity, then a marketing offer may be sent to that related individual. In other embodiments, the requesting entity may determine the appropriate action based on various business rules. For example, a high-valued customer may be contacted with a free customer service offer if comments of the high-valued customer's spouse on one or more social networks include complaints about a product or brand of the requesting entity and/or a product owned by the high-value customer. Another example may be a marketing offer made to a potential customer within the sphere of influence of a user making a very positive comment.

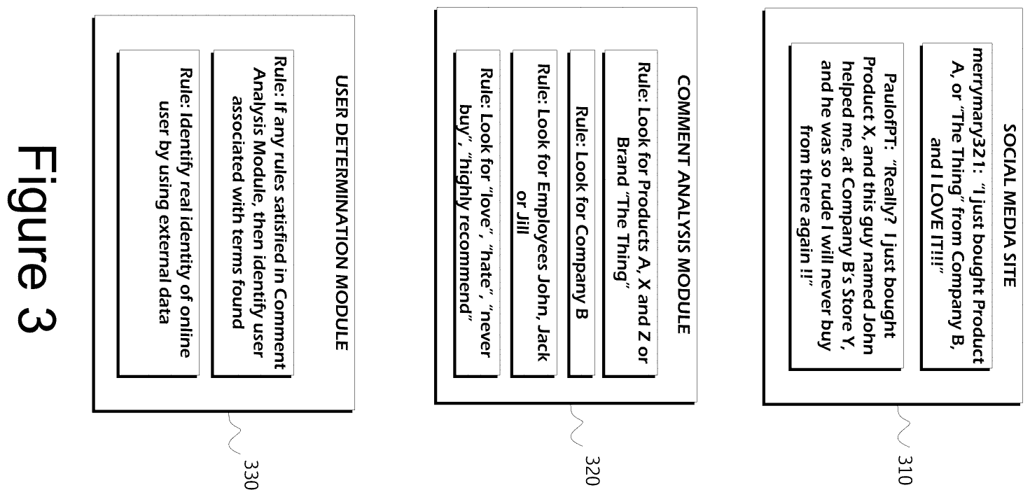

FIG. 3 is a diagram illustrating sample data and rules that may be used by various modules of an embodiment of the proactive offer system 100. FIG. 3 illustrates some example rules that may be used by the comment analysis module 170 and the user determination module 175. Other rules may also be used by the modules in other embodiments. Block 310 illustrates some example comments that may be found while scanning a social media site 108. In various embodiments, the comment analysis module 170 and the user determination module 175 may analyze the comments of block 310 to determine whether the comments may be of interest to the requesting entity, and, for comments of interest, to determine the real life identity of the social media user. In various embodiments, the comment analysis module 170 may be implemented on a system separate from the proactive offer system 100.

According to the sample rules shown in block 320, the comments made by merrymary321 and PaulofPT as shown in block 310 would be determined to be of interest to the requesting entity by the comment analysis module 170. For example, merrymary321's comment would satisfy the rule of mentioning “Product A”, as well as the rule of mentioning the sentiment “love”. Also, PaulofPT's comment would satisfy the rule of mentioning “Company B”, as well as the rule of mentioning the employee “John”.

According to the sample rules shown in block 330, since the comments made by merrymary321 and PaulofPT are determined to be of interest to the requesting entity, the user determination module 175 would identify the real identity of merrymary321 and PaulofPT using information outside of the social media site on which the comments were identified.

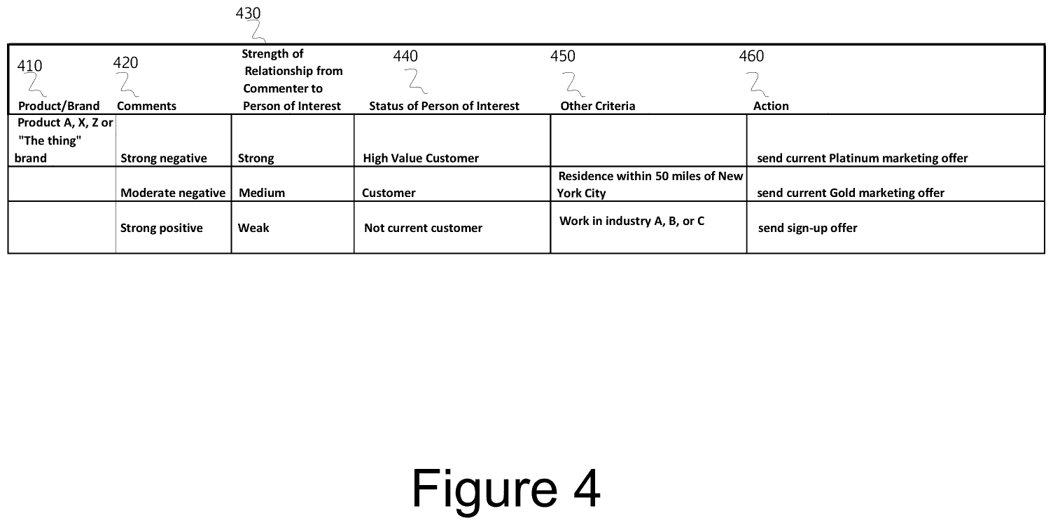

FIG. 4 is a table listing some variables and associated actions that may be used by an embodiment of the proactive offer system 100. Column 410 illustrates a sample rule that may be used by the comment analysis module 170 to determine which comments may be of interest to the requesting entity. As discussed in conjunction with FIG. 3 above, the comment analysis module 170 may determine that comments containing certain keywords, such as for example, comments containing reference to a specific product or brand are of interest to the requesting entity. Other rules may also be used by the comment analysis module 170. The rules may be based on the textual content of the comments, on the time of day of the comments, on the sentiment expressed in the comments, and the like. The criteria for determining comments of interest may be provided by the requesting entity, or may alternatively be developed by the proactive offer system 100.

Column 420 illustrates a sample set of tiers that the comment analysis module 170 may assign to individual comments. In some embodiments, the determination of comments of interest to the requesting entity may be based on the tier to which the comments are assigned. In other embodiments, the tiering of the comments may be performed following a determination that a given comment is of interest to the requesting entity. One example tiering is shown in Column 420, wherein the sentiment of a comment is qualified on a range of strongly positive to strongly negative. There may be intermediate tiers such as moderate positive, low positive, low negative and moderate negative, or any combination thereof. Other tierings may also be used, such as for example tierings based on the importance of a product or brand to the requesting entity, or tierings based on the time of day of the comment, or even tiering based on the user making the comment, for example. Similar to the rules used to determine comments of interest, the tierings associated with the comments may be provided by the requesting entity, or may alternatively be developed by the proactive offer system 100.

Column 430 illustrates examples of strength of relationship between a commenter and a person determined to be related to the commenter. In determining relationships between commenters and other individuals, the sphere of influence determination module 190 may also make a determination of the strength of the relationship. In some embodiments, the strength of the relationship may be a function of the type of relationship between the commenter and the related person. For example, a person determined to be in the same household with the commenter may be defined to have a strong relationship with the commenter, while a person determined to be a co-worker of the commenter may be defined to have a weak relationship. Alternatively, the strength of the relationship may be defined as a function of the confidence level associated with an identified relationship. For example, the sphere of influence determination module 190 may assign various confidence levels to identified relationships based on the reliability of the source used to determine the relationship, based on the number of sources used, based on the agreement of information between various sources, based on the recency of the information of the source, and the like. The criteria used to determine the strength of relationship may be defined by the requesting entity or by the proactive offer system 100.

Column 440 illustrates examples of status that may be associated with persons that may be of interest to the requesting entity. The status associated with individual may be determined and/or defined by the requesting entity, or by the value determination module 180 of the proactive offer system 100. The status associated with an individual may be an indication of the value of that individual to the requesting entity. Then, using the strength of the relationship between a commenter and an individual within the commenter's sphere of influence, as well as the value of that individual to the requesting entity, the proactive offer system 100 may make a determination of which action to recommend in relation to that individual.

As described above, the list of current customers may be provided by the requesting entity in conjunction with the initial request sent to the proactive offer system 100. In some embodiments, current customers may also be further qualified with an indication of their value to the requesting entity. In various embodiments, the value may be based on the total sales attributable to that customer, for example. The determination of the value of an individual may thus be based on information provided by the requesting entity. In other embodiments, the value determination module 180 may determine the value associated with a customer, and also the value associated with a potential customer. The determination may be made based on information obtained from demographic information 106, for example.

Columns 450 illustrate further example criteria that may be used by the action determination module 150 to identify customers of interest on which actions (e.g., the actions in column 460) may be recommend to the requesting entity. Column 450 illustrates example characteristics related to residence of the individual, the industry of employment of the individual, and the like. As with other criteria and rules, the types of characteristics to focus on, as well as the determination of which action to perform based on the characteristics may be defined by the requesting entity and/or the proactive offer system 100.

Column 460 illustrates some examples of actions that may be recommended to the requesting entity by the action determination module 150 (or taken by the proactive offer system 100 on behalf of the requesting entity). In this embodiment, based on the content of the comments, the strength of a relationship between an individual and the commenter, the status and value of that individual to the requesting entity, and some other possible characteristics associated with the individual, the most appropriate action to take to reach out to that individual may be determined by the action determination module 150. Alternatively, information regarding individuals located with a commenter's sphere of influence may be provided to the requesting entity, and the requesting entity may determine the appropriate action to perform. Some example actions that may be recommended may be to send a specific type of marketing offer to an existing customer, or a sign-up offer to a potential customer. Other actions may be defined by the requesting entity and/or the proactive offer system 100.

As shown in FIG. 4, using the example rules shown would include identification of individuals of interest meeting the following criteria:
high-value customers having a strong relationship to a consumer making a strong negative comment regarding the requesting entity's brand,
a customer of the requesting entity residing within a 50 mile radius of New York City and having a medium relationship to a consumer making a moderate negative comment regarding the requesting entity's brand, and
a prospective customer working in industry A, B, or C, and having a weak relationship to a strong positive comment regarding the requesting entity's brand.

According to FIG. 4, individuals matching the above criteria (e.g., individuals of interest), have different actions recommended and/or performed by the proactive offer system 100. In particular, the high-value customers having a strong relationship to a consumer making a strong negative comment regarding the requesting entity's brand would have a platinum marketing offer provided, while the prospective customer working in industry A, B, or C, and having a weak relationship to a strong positive comment regarding the requesting entity's brand may have a sign-up offer provided (either by the requesting entity or the proactive offer system 100). Thus, rules may developed to identify different classes of consumers of interest and customize actions that are taken with reference to those consumers of interest. In other embodiments, fewer criteria may be used to identify consumers of interest. For example, in some embodiments the strength of relationship may not be considered. Similarly, additional criteria may be used to identify consumers of interest, such as additional demographic or psychographic characteristics of individuals. In one embodiment, rules are ranked in order to resolve conflicts when an individual matches multiple rules.

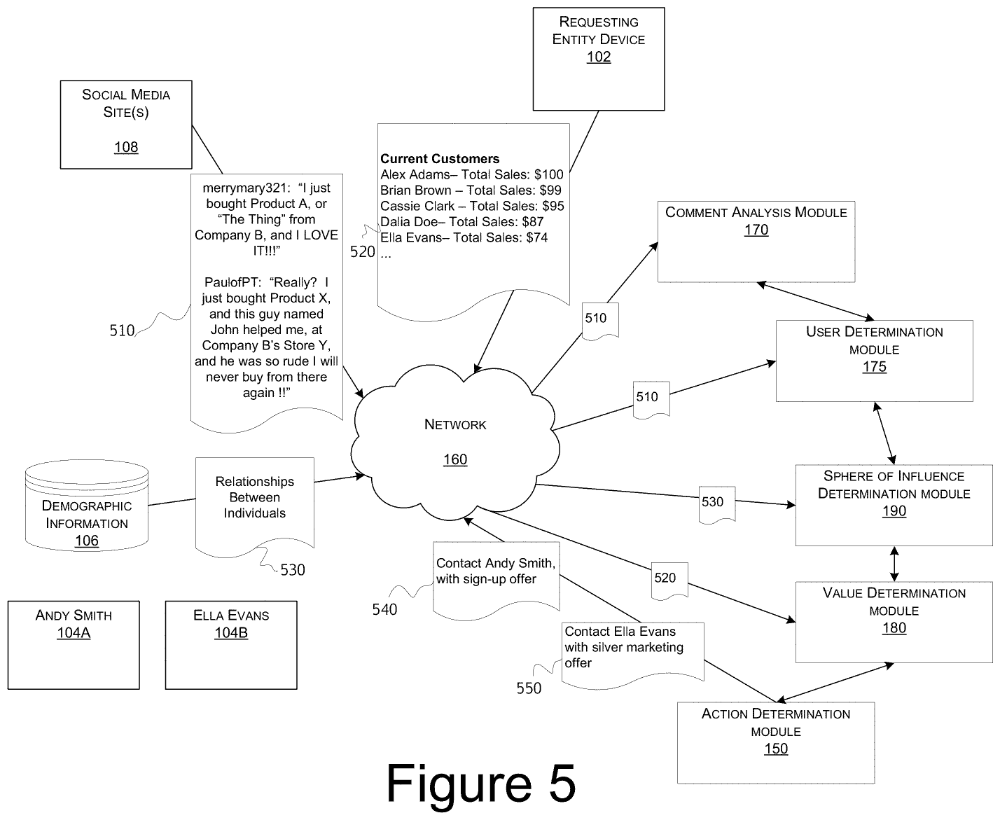

FIG. 5 is a block diagram illustrating sample data that may be communicated between various modules of an embodiment of the proactive offer system 100 for an example scenario. As illustrated in FIG. 5, the modules of the proactive offer system 100 (comment analysis module 170, user determination module 175, sphere of influence determination module 190, value determination module 180 and action determination module 150) may be in communication with one another through the network 160 and/or directly. In various embodiments, these modules may all be local to one another, or some may be co-located while others are remote. In this embodiment, the network 160 is also connected to a requesting entity device 102, social media sites 108 and demographic information 106.

The interaction between the various components as shown in FIG. 5 may start with the requesting entity sending a request via the requesting entity device 102 to the proactive offer system 100. In the example of FIG. 5, the request also includes a current customer list 520, as well as an indication of the total sales associated with each of those customers. Once the request is received by the proactive offer system 100, the comment analysis module 170 starts to scan social media sites 108. In other embodiments, the proactive offer system 100 may perform a periodic scanning of social media sites 108, asynchronous with requests from a requesting entity. As a result of the periodic scanning, keywords may be indexed on a scheduled basis (such as for example, nightly, weekly, and the like) so that the index may be consulted when a request is received.

In the scanning, comments 510 may be found. Then, the comments 510 may be analyzed by the comment analysis module 170 in order to determine that the comments 510 each satisfy one or more rules for being considered comments of interest to the requesting entity. The comments 510 and/or data associated with the commenter may then be accessed by user determination module 175 in order to determine the actual users (e.g., real world first and last name) associated with the comments 510 (merrymary321 and PaulofPT), the information is communicated to the sphere of influence determination module 190. In one example, merrymary321 may be determined to be Marie Smith, and PaulofPT may be determined to be Paul C. Doe by the user determination module 175.

Then, the sphere of influence determination module uses information regarding sphere of influence data 530, as determined using the demographic information 106, to determine (among possibly many other relationships and/or associations) that Marie Smith is related to Andy Smith by a familial relationship and that Paul C. Doe is related to Ella Evans by an employment relationship. The value determination module 180 may then determine, based on the list 520, whether those within the sphere of influence of Marie or of Paul meet the requesting entities criteria for individuals of interest (e.g., the various criteria of FIG. 4.) In this particular example, value determination module 180 determines that Andy Smith is not a current customer of the requesting entity and that Ella Evans is a current customer. In some embodiments, the value determination module 180 may further determine that Ella Evans is a low value customer, based on the relative sales associated with Ella.

The information from the value determination module 180 may then sent to the action determination module 150. The action determination module 150 may then recommend to the requesting entity to contact Andy Smith with a sign-up offer 540 and to contact Ella Evans with a silver marketing offer 550. Alternatively, the action determination module 150 may initiate the appropriate actions itself, such as by the proactive offer system 100 or by a third-party system.

### Other

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

All of the methods and processes described above may be embodied in, and partially or fully automated via, software code modules executed by one or more general purpose computers. For example, the methods described herein may be performed by the scoring system 100 and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A system for determining offers for individuals, the system comprising:
one or more computer processors configured to execute instructions;
one or more tangible computer readable medium storing instructions for execution by the one or more computer processors in order to cause the system to:
access rules of a requesting entity for identifying individuals to receive offers, the rules including at least:
comment criteria indicating one or more of a keyword, a keyword pattern, a key phrase, a time of day, or a sentiment expressed in online content associated with the individuals;
relationship criteria indicating one or more of a residence or employment relationship between two individuals, and including a strength of relationship between two individuals; and
a list of individuals of interest;
wherein the online content includes a plurality of social media sites;
for each of the plurality of social media sites:
access a plurality of user comments;
parse each of the plurality of user comments to identify a first set of user comments matching the comment criteria of the rules;
for each of the first set of user comments:
determine an online identity indicated on the social media site as responsible for posting the user comment;
determine a real-life identity associated with the online identity based at least in part on the associated first set of user comments, the real-life identity including at least a first name and a last name of a commenting individual;
access one or more third party databases to retrieve commenter information regarding the commenting individual, the commenter information including one or more of:
a residence location of the commenting individual; and
an employer of the commenting individual;
determine, based at least on the commenter information, a sphere of influence of the commenting individual, the sphere of influence indicating one or more persons having a predetermined relationship with the commenting individual, wherein said determining the sphere of influence is based on information regarding current residence or employer of the commenting individual gathered in demographic information reconciled from multiple third party databases, and wherein the sphere of influence includes at least one person not found on the social media site;
compare the one or more persons in the sphere of influence to the list of individuals of interest;
based on the comparison, identify one or more target individuals included in the sphere of influence and in the list of individuals of interest;
for each of the one or more target individuals:
determine, based on the commenter information, a strength of relationship between the target individual and the commenting individual, wherein the strength of relationship between the target individual and the commenting individual is based on one or more of a type of relationship between the target individual and the commenting individual or a confidence level associated with identification of the type of relationship;
wherein the confidence level associated with identification of the type of relationship is based at least in part on a reliability of a source used to determine the relationship, a number of sources used to determine the relationship, or the recency of the information associated with the source;
for each of the target individuals having at least the strength of relationship included in the relationship criteria:
determine an offer to provide to the target individual wherein the offer includes at least one of: a customer service offer or a marketing offer;
generate an electronic offer package configured for transmission to the target individual and including:
an indication of the target individual,
an indication of the requesting entity, and
an indication of the determined customer service or marketing offer; and
transmit the electronic offer package over a wireless communication channel to one or more remote devices associated with the target individual,
wherein the electronic offer package is configured to be displayed on the one or more remote devices.

2. (canceled)

3. (canceled)

4. The system of claim 1, wherein the relationship criteria further comprises at least one of a familial relationship of a particular degree, or a social network linkage.

5. The system of claim 1, wherein the list of individuals of interest comprises at least one of a list of customers, a list of potential customers, or a purchased marketing list.

6. The system of claim 1, wherein the list of individuals includes a value associated with each individual of interest to the requesting entity.

7. (canceled)

8. The system of claim 1, wherein the online identity indicated on the social media site is determined to be responsible for posting the user comment using information from a customer relationship management (CRM) repository associated with the social media site.

9. The system of claim 6, wherein the offer to provide to the target individual is based on the value associated with the target individual.

10. The system of claim 6, wherein the value associated with each individual of interest is based on total sales attributable to the individual of interest.

11. A method of determining offers for individuals, the method comprising:
receiving information associated with the individuals;
accessing rules of a requesting entity for identifying content, the rules including at least comment criteria, relationship criteria, and a list of individuals of interest to an entity, wherein the online content includes a plurality of social media sites;
accessing and processing the content to determine user comments made on the one or more of the plurality of social media sites;
identifying a user comment matching the comment criteria of the requesting entity rules, wherein the comment criteria includes one or more of: textual content, time of day, sentiment expressed;
determining a real-life identity of a commenting individual associated with the identified user comment, the real-life identity including at least a first name and a last name;
determining, using the real-life identity of the commenting individual, a sphere of influence of the commenting individual, the sphere of influence indicating one or more persons having various relationships with the commenting individual based on information regarding current residence and employment of the commenting individual gathered in demographic information reconciled from multiple third party databases;
identifying at least one of the one or more persons that are included on the list of individuals of interest;
determine a strength of relationship between the at least one of the one or more persons and the commenting individual, wherein the strength of relationship between the at least one of the one or more persons and the commenting individual is based on one or more of a type of relationship between the at least one of the one or more persons and the commenting individual or a confidence level associated with identification of the type of relationship, wherein the confidence level associated with identification of the type of relationship is based at least in part on a reliability of a source used to determine the relationship, a number of sources used to determine the relationship, or the recency of the information associated with the source;
for the at least one of the one or more persons having at least the strength of relationship included in the relationship criteria:
determining an offer to provide to the identified one or more persons, wherein the offer includes at least one of: a customer service offer or a marketing offer;
generating an electronic offer package configured for transmission to the identified one or more persons, the electronic offer package including (1) an indication of the identified one or more persons, (2) an indication of the requesting entity, and (3) an indication of the determined customer service offer or the marketing offer; and
transmitting the electronic offer package over a wireless communication channel to one or more remote devices associated with the identified one or more persons,
wherein the electronic offer package is configured to be displayed on the one or more remote devices.

12. (canceled)

13. The method of claim 11, wherein comment criteria comprises at least one of keywords or key phrases included in a comment.

14. The method of claim 11, wherein relationship criteria comprises at least one of a familial relationship, a familial relationship of a particular degree, or a social network linkage.

15. The method of claim 11, wherein the list of individuals of interest comprises at least one of a list of customers, a list of potential customers, or a purchased marketing list.

16. The method of claim 11, wherein the list of individuals includes a value associated with each individual of interest.

17. The method of claim 16, wherein the offer to provide is based on the value associated with each individual of interest.

18. (canceled)

19. (canceled)

20. A method of determining offers for individuals, the method comprising:
providing comments of interest to a computing device, wherein the comments are made by users of a social media site;
receiving an indication from the computing device of individuals determined to have a relationship to the users of the social media site who made the comments, wherein the individuals are determined to have a relationship with the users who made the comments using a real-life identity of the users determined based on information regarding current residence and employment of the commenting individual gathered in demographic information reconciled from multiple third party databases;
determining a proactive offer to send to the individuals having a strength of relationship to the users, wherein the strength of relationship between the individuals and the users is based on one or more of a type of relationship between the individuals and the users or a confidence level associated with identification of the type of relationship, wherein the confidence level associated with identification of the type of relationship is based at least in part on a reliability of a source used to determine the relationship, a number of sources used to determine the relationship, or the recency of the information associated with the source;
generating an electronic proactive offer package including (1) an indication of the individuals having a relationship to the users, and (2) an indication of the proactive offer; and
transmitting the electronic proactive offer package over a wireless communication channel to one or more remote devices,
wherein the electronic proactive offer package is configured to be displayed on the one or more remote devices.

21. The method of claim 20, wherein the proactive offer determined to send is based on a subset of user comments of interest.

22. A computing system comprising:
one or more computer processors configured to execute instructions;
one or more tangible computer readable medium storing instructions for execution by the one or more computer processors in order to cause the system to:
access rules of a requesting entity for identifying individuals to send offers based on analysis of online social media data posted online via a plurality of social media accounts, wherein the plurality of social media accounts are each associated with at least one individual having a real-life identity including a first and last name as well as a social media identity different than the first and last name, and wherein the online social media data includes online content on a plurality of social media sites;
wherein the rules include at least:
comment criteria indicating one or more keywords or key phrases of interest to be identified in the online content;
a list of individuals of interest to the requesting entity;
relationship criteria indicating one or more of a household or employment relationship requirement and indicia for determining strength of relationships of individuals; and
offer criteria indicating at least two or more electronic offers each associated with corresponding offer criteria;
access a plurality of social media comments of the online content, each social media comment associated with a particular social media identity and including one or more of: textual content, time of day, sentiment expressed;
apply the comment criteria to the social media comments to identify a first subset of the plurality of social media comments meeting the comment criteria;
for each of the identified first subset of social media comments meeting the criteria:
determine, using demographic information accessible from one or more data sources, a real-life identity of an individual associated with the social media identify and the social media account;
determine a sphere of influence of the identified individual by applying the relationship criteria to the real-life identity of the identified individual to determine one or more persons within the sphere of influence of the identified individual, the sphere of influence indicating one or more persons having a predetermined relationship with the identified individual based on information regarding current residence and employment of the identified individual gathered in demographic information reconciled from multiple third party databases;
determine, for each of the one or more persons within the sphere of influence of the identified individual, a strength of relationship with the identified individual based on the indicia for determining strength of relationships of individuals included in the relationship criteria, wherein the strength of relationship is based on one or more of a type of relationship between the identified individual and the person within the sphere of influence of the identified individual, or a confidence level associated with identification of the type of relationship, wherein the confidence level associated with identification of the type of relationship is based at least in part on a reliability of a source used to determine the relationship, a number of sources used to determine the relationship, or the recency of the information associated with the source;
determine whether any of the persons within the sphere of influence of the identified individual are on the list of individuals of interest to the requesting entity;
in response to determining that a first person within the sphere of influence of the identified individual matches a first individual on the list of individuals of interest to the requesting entity,
determine a first offer to be transmitted to the first individual of interest based on application of the offer criteria to data associated with the first person and/or the first individual on the list of individuals of interest, wherein the first offer includes at least one of: a customer service offer or a marketing offer;
generate an electronic offer package configured for transmission to the first individual of interest and including (1) an indication of the first individual of interest, (2) an indication of the requesting entity, and (3) an indication of the first offer; and
transmit the electronic offer package over a wireless communication channel to one or more remote devices associated with the first individual of interest, wherein the electronic offer package is configured to be displayed on the one or more remote devices.
